(19) United States
(12) Patent Application Publication
(10) Pub. No.: US 2026/0286585 A1
(43) Pub. Date: Sep. 24, 2026

(54) ARTICLE INCLUDING BLOWN MICROFIBERS AND FIRE BARRIER PARTICLES AND RELATED PROCESSES

(71) Applicant: 3M INNOVATIVE PROPERTIES COMPANY, St. Paul, MN (US)

(72) Inventors: John C. Hulteen, Afton, MN (US); Daniel E. Johnson, Marine On St. Croix, MN (US); Samantha D. Smith, Minneapolis, MN (US); S.M. Ibrahim Al-Rafia, Calgary (CA); Samantha L. Peterson, Woodbury, MN (US); Liyun Ren, Woodbury, MN (US)

(21) Appl. No.: 19/475,167

(22) PCT Filed: Apr. 12, 2024
(86) PCT No.: PCT/IB2024/053624

§ 371 Date: Oct. 14, 2025

Related U.S. Application Data
(60) Provisional application No. 63/459,529, filed on Apr. 14, 2023.
(60) Provisional application No. 63/459,544, filed on Apr. 14, 2023.

(51) Int. Cl. D04H 1/56; D04H 1/4209; D04H 1/4291; D04H 1/43

(52) U.S. Cl. CPC D04H 1/565; D04H 1/4209; D04H 1/4291; D04H 1/43; D10B 2101/08; D10B 2321/022; D10B 2321/10; D10B 2331/301; D10B 2401/04; D10B 2401/20

(57) ABSTRACT

An article has a first layer including a nonwoven web of blown microfibers and particles dispersed within the nonwoven web of blown microfibers. The particles include endothermic particles, intumescent particles, or both. The particles are present in an amount of at least 80 weight percent, based on a total weight of the first layer. The endothermic particles, intumescent particles, or both make up at least half of the total weight of the particles. Processes of making and using the article and use of the article as a fire barrier are also described.

### CROSS-REFERENCE TO RELATED APPLICATION

This application claims priority to U.S. Provisional Application Nos. 63/459,544 and 63/459,529, filed Apr. 14, 2023, the disclosures of which are incorporated by reference in their entirety herein.

### BACKGROUND

Products including inorganic fibers and either intumescent or endothermic materials have been reported, for example, for fire protection or thermal runaway protection in battery packs. See, for example, U.S. Pat. No. 5,384,188 (Lebold et al.), U.S. Pat. No. 8,178,177 (Frost et al.), U.S. Pat. No. 8,541,126 (Hermann et al.), U.S. Pat. No. 8,636,076 (Cordts et al.), U.S. Pat. No. 8,663,774 (Fernando et al.), U.S. Pat. No. 9,393,449 (Endle et al.), and U.S. Pat. No. 9,956,441 (Lalouch et al.), U.S. Pat. Appl. Pub. Nos. 2011/U.S. Pat. No. 0,126,957 (Wierzbicki e al.), 2015/U.S. Pat. No. 0,285,426 (Shaw), 2017/U.S. Pat. No. 0,098,806 (Bowersock et al.), and Int. Pat. Appl. Pub. Nos. WO 2006/097721 (James et al.) and WO 2022/024085 (Wu et al.).

### SUMMARY OF THE DISCLOSURE

The present disclosure provides an article useful, for example, for fire protection. The article includes a first layer with a high loading of particles including endothermic and/or intumescent particles with a small amount of blown microfibers. Typically, and advantageously, the blown microfibers can carry and deliver a large amount of endothermic and/or intumescent particles in a fire barrier article.

In one aspect, the present disclosure provides an article that has a first layer including a nonwoven web of blown microfibers and particles dispersed within the nonwoven web of blown microfibers. The particles include endothermic particles, intumescent particles, or both, and the particles are present in an amount of at least 80 weight percent, based on a total weight of the first layer. The endothermic particles, intumescent particles, or combination of endothermic and intumescent particles make up at least half of the total weight of the particles.

In another aspect, the present disclosure provides a process for making the article. The process includes forming the blown microfibers, delivering the particles to the blown microfibers, and collecting the blown microfibers and the particles to form the nonwoven web with the particles dispersed within the nonwoven web.

In another aspect, the present disclosure provides a process for providing a fire barrier to a surface. The process includes applying the aforementioned article to the surface.

In another aspect, the present disclosure provides use of the aforementioned article as a fire barrier.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. For example, the statement “at least one of A or B” has the same meaning as “A, B, or A and B.” All numerical ranges are inclusive of their endpoints and non-integral values between the endpoints unless otherwise stated (e.g., 1 to 5 includes 1, 1.5, 2, 2.75, 3, 3.8, 4, and 5).

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. In the processes described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

“Nonwoven web” means a plurality of fibers characterized by entanglement or point bonding of the fibers to form a sheet or mat exhibiting a structure of individual fibers or filaments which are interlaid, but not in an identifiable manner as in a knitted fabric.

“Particle” refers to a small distinct piece or individual part of a material (i.e., a primary particle) or aggregate thereof in finely divided form. Primary particles can include flakes, powders, and fibers, and may clump, physically intermesh, electrostatically associate, or otherwise associate to form aggregates.

The term “room temperature” as used herein refers to a temperature of about 20° C. to 25° C.

The term “ceramic” refers to glasses, crystalline ceramics, glass-ceramics, and combinations thereof.

### BRIEF DESCRIPTION OF THE FIGURES

The drawings illustrate generally, by way of example, but not by way of limitation, various embodiments discussed in the present disclosure.

FIG. 1 is a side view of an embodiment of the article of the present disclosure.

FIG. 2 is a greatly enlarged schematic representation of the blown microfibers and particles in the first layer of the article of the present disclosure.

FIG. 3 is schematic overall diagram of an illustrative apparatus for forming the first layer of the article of the present disclosure.

FIG. 4 is a side view of an embodiment of the article of the present disclosure including an adhesive layer and a polymeric film layer.

FIG. 5 is a side view of an embodiment of the article of the present disclosure including a foam layer.

FIG. 6 is a side view of an embodiment of the article of the present disclosure including a sealant layer.

FIG. 7 is a side view of an embodiment of the article of the present disclosure having a second layer comprising inorganic fibers adjacent the first layer and an outer covering at least partially encapsulating at least the first layer and the second layer.

FIG. 8 is a side view of an embodiment of the article of the present disclosure similar to that shown in FIG. 7 but having more than one second layer.

FIG. 9 is a side view of an embodiment of the article of the present disclosure similar to that shown in FIG. 7 but having more than one first layer.

FIG. 10 is a side view of an embodiment of the article of the present disclosure similar to that shown in FIG. 7 but having at least two first layers alternating with at least two second layers.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

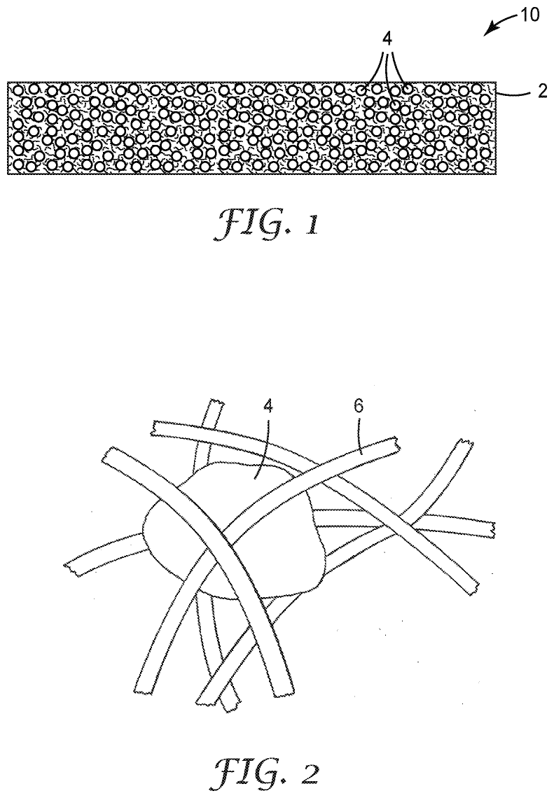

FIG. 1 illustrates an embodiment of the article 10 of the present disclosure. The article 10 includes a first layer 2 including a nonwoven web of blown microfibers and particles 4 dispersed within the nonwoven web of blown microfibers. The particles 4 include endothermic particles, intumescent particles, or both, and the particles 4 are present in an amount of at least 80 weight percent (wt. %), based on a total weight of the first layer 2. The endothermic particles, intumescent particles, or both make up at least half of the total weight of the particles 4.

Examples of blown microfibers suitable for the first layer 2 are generally organic polymeric (e.g., thermoplastic) fibers and include polyolefins (e.g., polypropylene, polyethylene, and polybutene), polyesters (e.g., polyethylene terephthalate and polybutylene terephthalate), polyamides, polyurethanes, polylactic acid, polyphenylene sulfide, polysulfone, liquid crystalline polymers, polyethylene-co-vinylacetate, polyacrylonitrile, cyclic polyolefins, and copolymers and blends thereof. In some embodiments, the blown microfibers comprise at least one of polyethylene terephthalate, polybutylene terephthalate, polyethylene, polypropylene, or polybutene. In some embodiments, the blown microfibers comprise polypropylene.

Particles 4 in the first layer 2 of the article of the present disclosure comprise at least one of endothermic particles or intumescent particles. In some embodiments, the particles 4 comprise the endothermic particles. In some embodiments, the particles 4 comprise the intumescent particles. The particles 4 are present in an amount of at least 80 wt. %, in some embodiments, in an amount of at least 82.5 wt. %, at least 85 wt. %, at least 87.5 wt. %, at least 90 wt. %, at least 92.5 wt. %, or at least 95 wt. %, based on the total weight of the first layer 2. In some embodiments, the endothermic particles are present in an amount of at least 40 wt. %, at least 50 wt. %, at least 60 wt. %, at least 70 wt. %, at least 80 wt. %, at least 82.5 wt. %, at least 85 wt. %, at least 87.5 wt. %, at least 90 wt. %, at least 92.5 wt. %, or at least 95 wt. %, based on the total weight of the first layer 2. In some embodiments, the intumescent particles are present in an amount of at least 40 wt. %, at least 50 wt. %, at least 60 wt. %, at least 70 wt. %, at least 80 wt. %, 82.5 wt. %, at least 85 wt. %, at least 87.5 wt. %, at least 90 wt. %, at least 92.5 wt. %, or at least 95 wt. %, based on the total weight of the first layer 2. In some embodiments, a combination of the endothermic particles and the intumescent particles are present in an amount of at least 40 wt. %, at least 50 wt. %, at least 60 wt. %, at least 70 wt. %, at least 80 wt. %, at least 82.5 wt. %, at least 85 wt. %, at least 87.5 wt. %, at least 90 wt. %, at least 92.5 wt. %, or at least 95 wt. %, based on the total weight of the first layer 2. The wt. % of particles can be determined using the Particle Loading Measurement method described in the Examples, below.

An endothermic particle is a particle that absorbs heat typically by releasing water of hydration. Examples of endothermic particles include nesquehonite (i.e., MgCO₃·3H₂O), calcium sulfate hydrate (i.e., gypsum, CaSO₄·2H₂O), magnesium phosphate octahydrate (i.e., Mg₃(PO₄)₂·8H₂O), aluminum hydroxide (i.e., aluminum trihydrate, Al(OH)₃), magnesium ammonium phosphate, magnesium hydroxide (i.e., Mg(OH)₂), magnesium hydroxide hydrate, hydromagnesite (i.e., Mg₅(CO₃)₄(OH)₂·4H₂O), dawsonite (i.e., NaAl(OH)₂CO₃), magnesium carbonate subhydrate (i.e., MgO·CO_{2(0.96)}H₂O_{(0.3)}), boehmite (i.e., AlO(OH), calcium hydroxide (i.e., Ca(OH)₂), hydrated zinc borate, and combinations thereof.

An intumescent particle is a particle that expands to at least about 1.5, 2, 5, 10, or 15 times its original volume upon heating to a temperature greater than its intumescence activation temperature. Intumescent particles expand to fill in gaps caused by shrinkage of materials caused by fire. An intumescent particle can expand at least 15 times, at least 30 times, at least 100 times or more when it is exposed to a fire. Examples of intumescent compounds include intumescent graphite; intumescent hydrated alkali metal silicates; unexpanded vermiculite; perlite; mica; organic intumescent compounds such as melamine (i.e., 2, 4, 6-triamino-1, 3, 5-triazine), azocarbonamide, and benzene sulfonyl hydrazide, which decompose to give off gases; and mixtures thereof.

Graphite is unexpanded in its naturally occurring form. It can be converted to intumescent graphite by intercalating chemical compounds, such as sulfuric acid, between the sp2-hybridized carbon sheets that comprise graphite. When graphite particles (e.g., flakes) are exposed to a temperature above the exfoliation temperature of the graphite (typically between 150° C. and 300° C.), the graphite layers separate from each other and expand to several times their original thickness. Intumescent graphite can include a plurality of flakes, which can have a mesh size independently in a range of from about 20 to about 350, about 50 to about 200, or about 50 to about 150 as measured by Standard USA Test Sieves conforming to ASTM E-11-09. Graphite such as “A4958” and “TC307” from Asbury Carbons, Inc., Asbury N.J., and “CYPBRID 1” from Imerys S. A., Paris, France, which are disclosed in U.S. Pat. Appl. Pub. No. 2022/0165242 (Mok et al.), are not intercalated and therefore not examples of intumescent graphite. Expanded graphite, such as vermiform graphite disclosed in U.S. Pat. Appl. Pub. No. 2021/0375251 (Lee et al.), is also not intumescent. The intercalated compound described above undergoes a phase change when heated and is no longer present between the layers after the graphite is expanded. Intumescent graphite can also be called expandable graphite and unexpanded, expandable graphite.

In some embodiments of the article and processes of the present disclosure, the particles comprise at least one of aluminum hydroxide, magnesium hydroxide, gypsum, intumescent graphite, unexpanded vermiculite, or an intumescent silicate. In some embodiments, the particles comprise at least one of aluminum hydroxide, intumescent graphite, or an intumescent silicate. In some embodiments, the particles comprise aluminum hydroxide and at least one of intumescent graphite or an intumescent silicate. In any of these embodiments including an intumescent silicate, the silicate is a hydrated alkali metal silicate. In some of these embodiments, the silicate is a mixture of alkali metal silicate, represented by the formula M₂O:xSiO₂, wherein M is the alkali metal; at least one oxy boron compound selected from the group consisting of boric acid and borate salts of Group I and II elements; and water; wherein x ranges from about 1.5 to about 4, a molar ratio of boron to M is between about 0.2 and about 0.9, and the water makes up about 5 to 15 weight percent of the mixture. Such intumescent silicates are described in U.S. Pat. No. 4,521,333 (Graham et al.). In some embodiments, the particles comprise gypsum.

In some embodiments of the article and processes of the present disclosure, the blown microfibers and particles 4 comprising at least one of the endothermic particles or intumescent particles make up at least 80, 85, 90, 95, 96, 97, 98, or 99 percent of the total weight of the first layer 2. The blown microfibers and particles 4 may make up 100 percent of the total weight of the first layer 2.

In some embodiments of the articles and processes of the present disclosure, the particles further comprise flame-retardant particles. Examples of flame-retardant particles include phosphorous-containing compounds, nitrogen-containing polymers, boron-containing compounds, antimony oxide, a humite/hydromagnesite blend, wollastonite, glass frit (e.g., as disclosed in U.S. Pat. No. 4,879,066 (Crompton)), and mixtures thereof. The flame-retardant particles may be present in the first layer in an amount of not more than 20, 15, 10, 5, 4, 3, 2, or 1 percent of the total weight of the particles. The term “phosphorous-containing flame retardant” as used herein means that the flame retardant includes at least one phosphorous atom. Thus, this element may also be called a “phosphorous atom-containing flame retardant”. The term “nitrogen-containing polymer” as used herein means that the polymer includes at least one nitrogen atom. Thus, this element may also be called a “nitrogen atom-containing polymer”.

Examples of suitable phosphorous-containing flame retardant particles include phosphates, polyphosphates, phosphonates, phosphinates, phosphazenes, phosphines, phosphine oxides, and combinations thereof. Useful phosphorous-containing flame retardants include red phosphorus; tri(2-chloroethyl)phosphate (TCEP); tri(2-chloropropyl)phosphate (TCPP); tri(2,3-dichloropropyl)phosphate (TDCP); mono-ammonium phosphate; di-ammonium phosphate; triphenylphosphate; those obtained from Clariant Corporation, Charlotte, N.C., under the trade designations “EXOLIT OP” in various grades and “EXOLIT RP”; ammoniumpolyphosphate (APP); melamine phosphate (MP); tri(2,3-dibromopropyl)phosphate; tetrakis(hydroxymethyl)phosphoniumchloride (THPC); cyclic phosphate derivatives; phosphorus-containing polyol polyether; tri(chloroethyl)phosphate; zinc phosphate; trimethylphosphonate; trimethyl phosphate; guanidine phosphate; ammonium dihydrogen phosphate; diammonium hydrogen phosphate; tribenzyl phosphate; melamine polyphosphate (salt) (MPP); triphenylphosphine (TPP); triphenylphosphine (TPPO); tri(beta-chloroethyl)phosphate (TCEP); dimethyl methylphosphate (DMMP); and tri(bromophenyl)phosphate (PB-460), ethylene diamine phosphate, magnesium ammonium phosphate, polymer-encapsulated ammonium polyphosphate, and organic phosphate oils. Suitable nitrogen-containing polymers include polyurethanes, urea-formaldehyde resin, melamine-formaldehyde resin, melamine-urea-formaldehyde resin, and polyimides. Some phosphorous-containing flame retardants encapsulated in a crosslinked, nitrogen-containing polymer are commercially available, for example, ammonium polyphosphate micro-encapsulated with melamine resin is available under the designations “EXOLIT AP 462” from Clariant Corporation, Charlotte, N.C., and “FR CROS 487” from Budenheim, Mansfield, Ohio.

In some embodiments of the articles and processes of the present disclosure, the particles further comprise inorganic filler. The inorganic filler may be present in the first layer in an amount of not more than 20, 15, 10, 5, 4, 3, 2, or 1 percent of the total weight of the particles.

Suitable inorganic fillers include glass fibers, aluminum silicate (mullite), synthetic calcium silicate, zirconium silicate, fused silica, crystalline silica graphite, natural silica sand, boron powders (e.g., boron-nitride powder or boron-silicate powders, oxides (e.g., TiO₂, aluminum oxide (particulate or fibrous), magnesium oxide, or zinc oxide), calcium carbonate (e.g., chalk, limestone, marble, or synthetic precipitated calcium carbonates), talc (e.g., fibrous, modular, needle shaped, or lamellar talc), solid ceramic spheres (e.g., solid glass spheres), kaolin (e.g., hard kaolin, soft kaolin, or calcined kaolin), single crystal fibers or “whiskers” (e.g., of silicon carbide, alumina, boron carbide, iron, nickel, or copper), fibers, including continuous and chopped fibers, (e.g., asbestos or carbon fibers) and short inorganic fibers such as those derived from blends including at least one of aluminum silicates, aluminum oxides, magnesium oxides, or calcium sulfate hemihydrate, sulfides (e.g., molybdenum sulfide or zinc sulfide), barium compounds (e.g., barium titanate, barium ferrite, barium sulfate, or heavy spar), metals (e.g., bronze, zinc, copper and nickel metal mesh or metal plate), flaked fillers (e.g., glass flakes, flaked silicon carbide, aluminum diboride, aluminum flakes, or steel flakes), mica, clay, feldspar, flue dust, fillite, quartz, quartzite, perlite, Tripoli, diatomaceous earth, carbon black, and combinations of any of these inorganic fillers. Further examples of inorganic fillers include inorganic fibers described below in connection with the second layer, in any of their embodiments. Inorganic fillers (in some embodiments, fibers) in the first layer may be useful for enhancing the durability and heat resistance of the first layer.

In some embodiments of the articles and processes of the present disclosure, the particles further comprise staple fibers. Staple fibers can include any of the inorganic fibers described above in any of their embodiments in connection with the inorganic fillers and in connection with the second layer such as ceramic fibers and glass fibers. Staple fibers incorporated in this manner can also include polyphenylene sulfide fibers and oxidized polyacrylonitrile (OPAN) fibers, which may be useful for increasing the durability and/or heat resistance in some embodiments of the first layer. The staple fibers may be present in the first layer in an amount of not more than 50, 40, 35, 20, 15, 10, 5, 4, 3, 2, or 1 percent of the total weight of the particles.

In some embodiments of the articles and processes of the present disclosure, the particles further comprise char-forming organic particles. “Char” is a carbonaceous residue formed upon heating a char forming material to a temperature of greater than about 250° C., as would be experienced when exposed to flames. The char formed is often resistant to erosion due to the heat and pressures encountered during a fire. Char forming additives are generally organic compounds. In some embodiments of the articles and processes of the present disclosure, the particles further comprise organic particles, which may be useful as char forming additives. Useful char forming resins include vinyl acetate homopolymer, epoxy resins, phenolic resins, polycarboimide resins, urea-formaldehyde resins, and melamine-formaldehyde resins.

Typically, and unexpectedly, in embodiments in which the blown microfibers comprise polypropylene in the first layer, the first layer forms such an erosion-resistant char. The char-forming organic particles may be present in the first layer in an amount of not more than 20, 15, 10, 5, 4, 3, 2, or 1 percent of the total weight of the particles.

The nonwoven web of blown microfibers is made using a melt blowing process. Blown microfibers are also known as melt blown fibers. Melt blown nonwoven webs can contain very fine fibers. In a melt blowing process, one or more thermoplastic polymer streams are extruded through a die containing closely arranged orifices. These polymer streams are attenuated by convergent streams of hot air at high velocities to form fine fibers, which are then collected on a surface to provide a melt blown nonwoven fibrous layer. Depending on the operating parameters chosen, the collected fibers may be semi-continuous or essentially discontinuous.

The blown microfibers of the nonwoven web can have any suitable diameter. In some embodiments, the fibers can have an effective fiber diameter of from 0.1 micrometers (μm) to 60 μm, from 1 μm to 20 μm, from 1 μm to 10 μm, or from 5 μm to 7 μm. Effective fiber diameter is determined using the method described in the Examples below.

Particles introduced into the gaseous stream carrying the microfibers become intermixed with the microfibers. A plurality of entangled microfibers tends to wrap around the particles, causing the particles to be physically held in the fibers. It is believed that the fine size and conformability of blown microfibers make it possible for a limited volume of fiber material to have a vast number of point contacts with the particles. Thus, the combination of blown microfibers and particles in the first layer provides a unique structure.

When particles are introduced into a gaseous stream carrying blown microfibers, the mixing of the particles and the microfibers can occur at a location spaced from the die where the microfibers have become nontacky. Thus, in these embodiments, the particles are not adhered to the microfibers. The particles can be held within the web despite the fact that the blown microfibers have no more than point contact with the particles. “Point contact” occurs when preformed bodies abut one another. It is distinguished from area contact, such as results when a liquid material is deposited against a substrate, flows over the substrate, and then hardens in place.

FIG. 2 is a schematic representation of the blown microfibers 6 and a particle 4 in the first layer of the article of the present disclosure. As shown in FIG. 2, the particle 4 is physically held by a plurality of the blown microfibers 6. Referring again to FIG. 1, in some embodiments, the particles 4 are dispersed throughout the entire thickness of the first layer 2. In some embodiments, the particles 4 are dispersed uniformly across its entire thickness of the first layer 2.

The process for making the article of the present disclosure includes forming the blown microfibers, delivering the particles to the blown microfibers, and collecting the blown microfibers and the particles to form the nonwoven web with the particles dispersed within the nonwoven web. The particles can be incorporated into the nonwoven web either during or after the formation of the blown microfibers. In a melt blowing process, the particles may be conveyed and co-mingled with the streams of molten polymer as they are blown onto a rotating collector drum. The particles may be entrained within a flow of heated air that converges with the hot air used to attenuate the blown microfibers. In this process, for example, forming the blown microfibers and delivering the particles to the blown microfibers are carried out simultaneously. Embodiments of such a process are described in U.S. Pat. No. 3,971,373 (Braun).

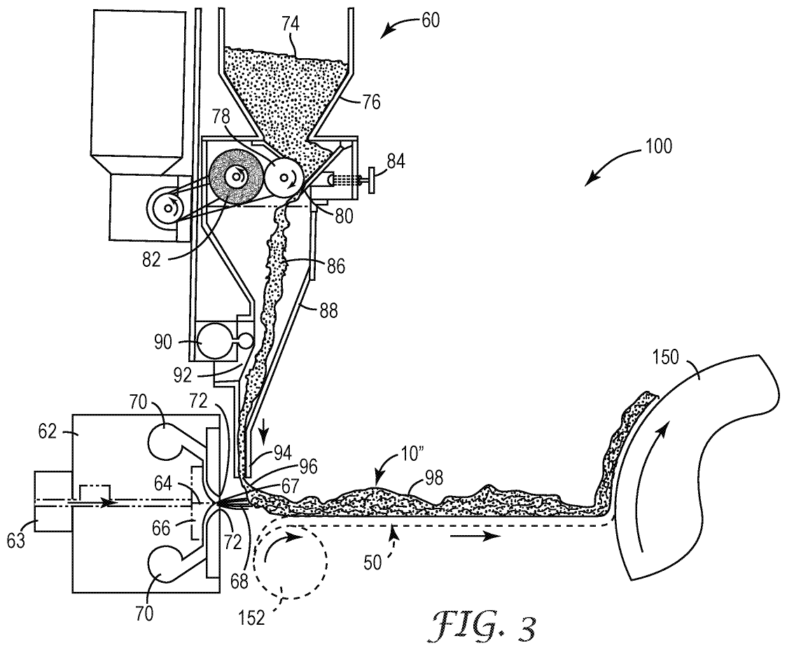

FIG. 3 is schematic overall diagram of an illustrative apparatus 100 for making an article according to the present disclosure. FIG. 3 illustrates use of the particulate-loading apparatus 60 for making a first layer using a melt-blowing process. In the illustrative apparatus, molten fiber-forming polymeric material enters nonwoven die 62 via inlet 63, flows through die slot 64 of die cavity 66 (all shown in phantom), and exits die cavity 66 through orifices such as orifice 67 as a series of filaments 68. An attenuating fluid (typically air) conducted through air manifolds 70 attenuates filaments 68 into fibers 98 at die exit 72.

Meanwhile, particulates 74 pass through hopper 76 past feed roll 78 and doctor blade 80. Motorized brush roll 82 rotates feed roll 78. Threaded adjuster 84 can be moved to improve cross-web uniformity and the rate of particulate leakage past feed roll 78. The overall particulate flow rate can be adjusted by altering the rotational rate of feed roll 78. The surface of feed roll 78 may be changed to optimize feed performance for different particulates. A cascade 86 of particulates 74 falls from feed roll 78 through chute 88. Air or other fluid passes through manifold 90 and cavity 92 and directs the falling particulates 74 through channel 94 in a stream 96 amidst filaments 68 and fibers 98 of the polymeric material. The mixture of particulates 74 and fibers 98 forms a self-supporting first layer 10″, and lands against porous collector 150. Optionally, optional support layer 50 may be fed from optional roll 152 and used to collect and support first layer 10″.

In some embodiments, staple fibers may also be injected into the stream of filaments and fibers during a melt blowing process. Staple fibers can include any of those described above.

In view of the molten polymer and hot air used in the process illustrated in FIG. 3, it was unexpected that intumescent particles can be delivered simultaneously with the formation of the blown microfibers. Unexpectedly, we have found that the process does not cause the intumescence of the intumescent particles, despite the heat needed to melt the polymer and attenuate the polymer filaments.

Generally, past approaches to incorporating intumescent particles into a fiber matrix included a dry-laid method and a wet-laid method. Both methods require an organic binder to hold the particles into the fiber matrix, and the particle loading is generally limited to 50 wt. % to 70 wt. %. In the article and processes of the present disclosure, the particles are present in an amount of at least 80 wt. %, based on a total weight of the first layer, and may be present in an amount of up to 95 wt. % or more. Advantageously, the article and processes of the present disclosure do not require any organic binder, and the reduction in organic binder reduces the combustibility and increases the flexibility of the presently disclosed article. In some embodiments, the article of the present disclosure and/or made by the process of the present disclosure is essentially free of organic material other than the blown microfibers. “Essentially free” as used herein means that the article of the present disclosure and/or made or used in the processes of the present disclosure has less than 1 wt. %, 0.5 wt. %, 0.25 wt. %, 0.1 wt. %, 0.05 wt. %, or 0.01 wt. %, based on the total weight of the article, of organic material other than the blown microfibers.

Article 10, shown in FIG. 1, can be useful, for example, in building construction instead of or in combination with gypsum board. Gypsum board is often used to “box in” an item that needs protection in fire protection systems. Gypsum board is typically heavy and inflexible. The first layer 2 in the article 10 of the present disclosure may be compressed to any desired thickness and rigidity to provide a highly loaded fire barrier that is advantageously thinner and easier to use than gypsum board. Particles 4 can comprise gypsum or any of the endothermic particles or intumescent particles described above in any of their embodiments, or combinations thereof. An article 10 that is not compressed after it is made or compressed to an extent such that it remains flexible can advantageously be applied to curved surfaces. An article 10 can also be used in combination with gypsum board (not shown) to enhance its fire barrier properties without adding significant thickness.

The article of the present disclosure and/or made by the process of the present disclosure can be useful, for example, for replacing sealants in a variety of fire protection applications. For example, it can be useful to block a through penetration and/or wrapped around a pipe and placed in an opening in a variety of construction and industrial applications. Also, the article of the present disclosure can be useful to lay out on top of a wall track or otherwise applied in a head-of-wall application and useful in a curtain wall joint. Article 10 can replace paints or sprays in cable firestop applications and structural steel coating. In these applications, the article can include any of the endothermic particles or intumescent particles described above in any of their embodiments, or combinations thereof. The article of the present disclosure can be advantageous over sealants, which are messy to apply, require time for curing, and may be difficult to highly load with particles.

The article of the present disclosure and/or made by the process of the present disclosure can be useful, for example, instead of or in combination with layers or pillows of inorganic (e.g., ceramic) fibers for a variety of applications. Wraps of inorganic (e.g., ceramic) are typically thick to provide the desired performance for fire stopping application. The article of the present disclosure can be placed adjacent to a layer of inorganic (e.g., ceramic) fibers or between two of such layers, which may reduce the thickness of the wrap and/or provide better firestopping performance. Wraps including the article of the present disclosure used alone or in combination with a layer of inorganic fibers may have an outer covering such as any of those described below. In these applications, the article can include any of the endothermic particles or intumescent particles described above in any of their embodiments, or combinations thereof.

In some embodiments of the article of the preset disclosure and/or made or used in the processes of the present disclosure, the article includes a second layer or multiple layers. In some embodiments, the article comprises at least one of an adhesive layer, a polymeric film layer, a foam layer, a sealant layer, a layer comprising inorganic fibers, a flame barrier paper layer, or an outer covering comprising a metal at least partially encapsulating at least the first layer.

In some embodiments of the article of the preset disclosure and/or made or used in the processes of the present disclosure, the article includes an adhesive layer. Adhesive layers can be useful for applying the article to a substrate in several of the applications described above (e.g., head-of-wall applications, structural steel coating, and pipe and cable wraps). In some embodiments, the adhesive layer comprises a pressure-sensitive adhesive (PSA). PSAs are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. One method useful for identifying PSAs is the Dahlquist criterion. This criterion defines a pressure sensitive adhesive as an adhesive having a 1 second creep compliance of greater than 1×10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 1×10⁶ dynes/cm². Examples of PSAs suitable for the adhesive layer include natural rubber-, acrylic-, block copolymer-, silicone-, polyisobutylene-, polyvinyl ether-, polybutadiene-, or and urea-based pressure sensitive adhesive and combinations thereof. These PSAs can be prepared, for example, as described in Adhesion and Adhesives Technology, Alphonsus V. Pocius, Hanser/Gardner Publications, Inc., Cincinnati, Ohio, 1997, pages 216 to 223, Handbook of Pressure Sensitive Adhesive Technology, Donatas Satas (Ed.), 2nd Edition, Van Nostrand Reinhold, New York, NY, 1989, Chapter 15, and U.S. Pat. No. Re 24,906 (Ulrich).

In some embodiments of the article of the preset disclosure and/or made or used in the processes of the present disclosure, the article includes a polymeric film layer. The polymeric film layer may be monolithic (e.g., non-porous, non-fibrous, or not perforated). Polymeric materials suitable as a film for an adhesive article include polyesters; polycarbonates; polyolefins (e.g., polyethylene); ethyl cellulose film; cellulose esters (e.g., cellulose acetate, cellulose acetate butyrate, and cellulose propionate); polyvinylidene chloride-vinyl chloride and/or acrylonitrile polymers such as saran; vinyl chloride polymers (e.g., copolymers of vinyl chloride and vinyl acetate); polyfluoroethylenes (e.g., polytetrafluoroethylene and polytrifluorochloroethylene); polyvinyl alcohol; polyamides such as nylon; polystyrenes such as the copolymers of styrene and isobutylene; regenerated cellulose; benzyl cellulose; cellulose nitrate; gelatin; glycol cellulose; polyacrylates and polymethacrylates; urea aldehyde films; polyvinyl acetal; and polyvinyl butyral. In some embodiments, the article comprises a polymeric film layer comprising at least one of polyester, polycarbonate, polyolefin, or acrylic onto which an adhesive is disposed to provide the adhesive surface. One or more layers of any of these materials may be useful to form a polymeric film. Optionally, the polymer film layer may include deposited metal layers such as aluminum, silver, and nickel. In some embodiments, the first layer may be formed, for example, by melt-blowing directly onto a polymeric film layer as a support layer 50 shown in FIG. 3. In other embodiments, the first layer may be adhesively laminated to the polymeric film layer.

In some embodiments of the article of the preset disclosure and/or made or used in the processes of the present disclosure, the article includes a foam layer. Suitable foams for the foam layer include open cell foams and closed cell foams. The foam can be made from a variety of materials, for example, polyurethane (e.g., polyether polyurethane and polyester polyurethane), EPDM, nitrile, PVC, polyethylene, polypropylene, polystyrene, ethylene-vinyl acetate (EVA), neoprene, and styrene-butadiene rubber. The foam can have a variety of densities including a range from 0.4 pounds/square foot (lbs./ft.²) to 10 lbs./ft.² (1.95 kilograms per square meter (kg/m²) to 48.8 kg/m²). In some embodiments, the first layer may be formed, for example, by melt-blowing directly onto a foam layer. In some embodiments, the first layer may be at least one of adhered, ultrasonically bonded, needle-tacked, or stitch bonded to the foam layer.

In some embodiments of the article of the preset disclosure and/or made or used in the processes of the present disclosure, the article includes a sealant layer. The sealant layer can include a curable polymer (i.e., a thermosetting polymer). In some embodiments, the curable polymer can be a moisture-cured polymer, a thermally-cured polymer, or a radiation-cured polymer. Examples of curable polymers useful as sealants include acrylic polymers, polyurethane polymers, silicone polymers, and epoxy resins. In some embodiments, the sealant includes an elastomeric sealant, which may or may not be curable. In some embodiments, the elastomeric sealant is applied as a latex. Useful latexes include polychloroprene (e.g., which may include an HCl scavenger such as zinc oxide), acrylate polymers, natural rubbers, styrene butadiene copolymers, butadiene acrylonitrile copolymers, polyisoprene, ethylene/vinyl acetate copolymers, polybutadiene, and combinations thereof. The sealant layer may be in the form of a continuous layer, a discontinuous layer (e.g., having perforations, through-holes, or porosity), or a combination of both. The sealant layer may be applied by hot-melt coating, spray coating, dip coating, or any desirable coating method.

In some embodiments of the article of the preset disclosure and/or made or used in the processes of the present disclosure, the article includes a second layer comprising inorganic fibers. Examples of suitable inorganic fibers include refractory ceramic fibers, alkaline earth silicate fibers, mineral wool fibers, polycrystalline wool (PCW) fibers, basalt fibers, leached glass silica fibers, fiberglass, glass fibers, carbon fibers, high alumina polycrystalline fibers, and mixtures thereof. The inorganic fibers can be alumina, zirconia, or silica spun ceramic fibers, for example, or a combination thereof. In some embodiments, the second layer includes mineral wool. In some embodiments, the mineral wool fibers include at least one of rock wool fibers, slag wool fibers, basalt fibers, glass wool fibers, and diabasic fibers. Mineral wool fibers may be formed from basalt and industrial smelting slags, for example, and typically comprise silica, calcia, alumina, and/or magnesia. Glass wool fibers are typically made from a fused mixture of sand and recycled glass materials. In some embodiments, the inorganic fibers comprise a calcium magnesium silicate fiber or amorphous calcium, magnesium, silicate (alkaline-earth-silicate greater than 18%) fiber that is soluble in body fluids.

In some embodiments, the inorganic fibers in the second layer of the article of the present disclosure and/or made or used in the processes of the present disclosure comprise ceramic fibers. Examples of suitable ceramic fibers include alumina fibers, alumina-silica fibers, alumina-zirconia-silica fibers, zirconia-silica fibers, zirconia fibers, and similar fibers. Refractory ceramic fibers (RCF) are a fiberization product that may be blown or spun from a melt of the component materials. RCF fibers typically comprise alumina and silica, and in some embodiments, the alumino-silicate RCF may comprise from about 45 to about 60 percent by weight alumina and from about 40 to about 55 percent by weight silica. RCF may additionally comprise the fiberization product of alumina, silica and zirconia, in some embodiments, in the amounts of from about 29 to about 31 percent by weight alumina, from about 53 to about 55 percent by weight silica, and about 15 to about 17 weight percent zirconia.

The second layer of the article of the present disclosure and/or made or used in the processes of the present disclosure may also include an inorganic binder. Examples of suitable inorganic binders include colloidal silica, colloidal alumina, colloidal zirconia, sodium silicate, and clays (e.g., bentonite, hectorite, kaolinite, montmorillonite, palygorskite, saponite, or sepiolite), and combinations thereof. In some embodiments, the inorganic fibers in the second layer are interlaced or entangled.

Some materials useful as second layers comprising inorganic fibers in the article and/or processes of the present disclosure are commercially available, including a spun ceramic fire blanket, such as that obtained under the trade designation “DURABLANKET” from Unifrax Corp, Tonawanda, NY, and a duct wrap obtained under the trade designation “3M FIRE BARRIER DUCT WRAP 615+” from 3M Company, St. Paul, MN.

The first layer may be at least one of adhered, ultrasonically bonded, needle-tacked, or stitch bonded to the second layer comprising inorganic fibers. Alternatively, or in combination, physical entanglement of fibers may be used to join the first layer and the second layer. The use of mechanical fasteners is also possible. In some embodiments, the nonwoven web of blown microfibers may be formed, for example, by melt-blowing, directly on a pre-manufactured second layer comprising inorganic fibers such as any of those described above.

In some embodiments of the article of the preset disclosure and/or made or used in the processes of the present disclosure, the article includes an outer covering. Outer coverings can be useful for blankets, wraps, and pillows such as those described above. In some embodiments, the outer covering comprises a metal. In some embodiments, the metal comprises at least one of stainless steel, aluminum, or copper. Examples of an outer covering comprising metal include metalized cloth (e.g., including fibers of stainless steel, aluminum, or copper, for example) and foils comprising metal (e.g., aluminum foil, stainless steel foil, or metalized polymeric foil such as a metalized polyester foil). In some embodiments, the outer covering includes multiple layers. In some embodiments, the outer covering includes a scrim. In some embodiments, the outer covering is a scrim-reinforced metal foil. The scrim may be a fiberglass scrim, and the metal foil may be any of those described above. In some embodiments, the outer covering comprises a fiberglass reinforced metalized polymer (in some embodiments, polyester) foil. In some embodiments, the outer covering comprises a three-ply laminate comprising a fiberglass scrim located between two aluminized polyester foils. In some embodiments, the outer covering is not perforated and/or not porous. Perforated films are comprised of a solid layer having a multiplicity of perforations, or through-holes, extending through the solid layer. Microperforated films are perforated films having apertures whose diameters are on the order of micrometers. Some materials useful as outer coverings in the article and/or processes of the present disclosure are commercially available, for example, a three-ply foil-faced laminate including a fiberglass scrim adhered with a fire-retardant thermosetting adhesive to an aluminized polyester face with an aluminum foil backing manufactured by Alpha Alaflex Associates Inc., Lakewood, NJ.

In some embodiments of the process for making the article of the present disclosure, the process includes positioning the first layer next to the second layer and wrapping the outer covering at least partially around the first layer and the second layer. In some embodiments, the process further includes joining the first layer and the second layer using any of the methods described above. In some embodiments, the nonwoven web of blown microfibers may be formed, for example, by melt-blowing, directly on a pre-manufactured outer covering such as any of those described above.

In some embodiments of the article of the preset disclosure and/or made or used in the processes of the present disclosure, the article includes a comprises a flame barrier paper. A suitable flame barrier paper is a flexible 100% m-aramid paper that is commercially available, for example, from DuPont de Nemours, Inc., Wilmington, Del., under the trade designation “NOMEX 410”. In some embodiments, the flame barrier paper comprises an inorganic paper, and in some embodiments, a ceramic paper. In some embodiments, the flame barrier paper comprises a flexible mica paper. Useful mica papers can comprise mica and a glass scrim. Some suitable flame barrier papers are ceramic papers commercially available, for example, from 3M Company, St. Paul, Minn., under the trade designation “3M FLAME BARRIER FRB-NT SERIES”. Other suitable flame barrier papers are glass fiber and microfiber inorganic insulating papers commercially available, for example, from 3M Company, under the trade designation “3M CEQUIN I, II, 3000 Inorganic Insulating Paper”. Other similar papers may also be useful. In some embodiments, the flame barrier paper has a thickness of up to 0.40 mm, up to 0.30 mm, or up to 0.20 mm. In some embodiments, the flame barrier paper has a thickness of at least 0.05 mm, at least 0.075 mm, or at least 0.10 mm.

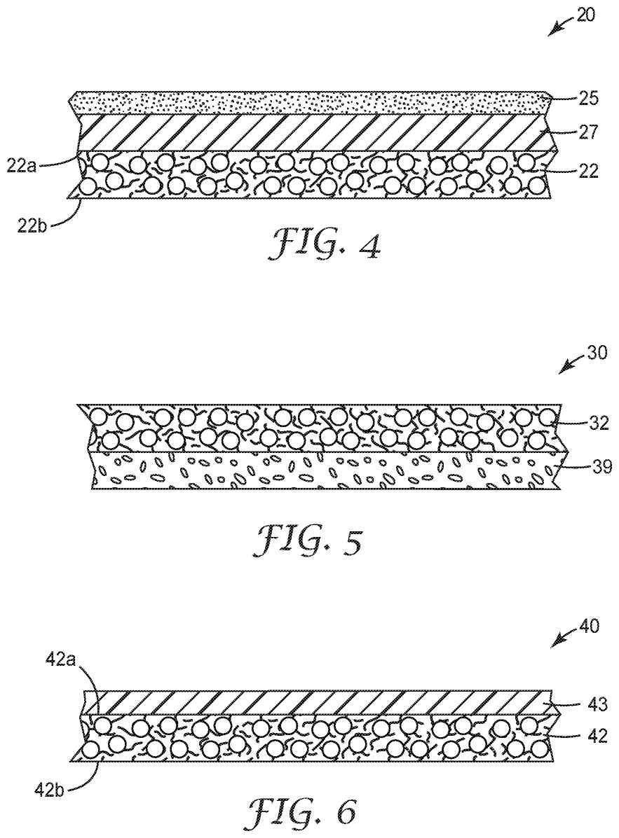

Returning now to the drawings, FIG. 4 illustrates an embodiment of the article 20 of the present disclosure. The article 20 includes a first layer 22 including a nonwoven web of blown microfibers and particles dispersed within the nonwoven web of blown microfibers. The article 20 also includes a polymeric film layer 27 and an adhesive layer 25. In the illustrated embodiment, the polymeric film layer 27 is adjacent to the first major surface 22a of the first layer 22, and the adhesive layer 25 is adjacent to the polymeric film layer on a surface opposite the first layer. As described above, the first layer 22 may be directly formed on the polymeric film layer 27. The first layer 22 may also be adhesively laminated to the film layer 27 such that there is an adhesive layer (not shown) between the polymeric film layer 27 and the first layer 22. The particles, blown microfibers, polymer film layer, and adhesive layer can be any of those described above in any of their embodiments. Instead of a polymer film, layer 27 may also be a paper backing or a foam backing. In article 20, adhesive layer 25 can be useful for applying the article 20 to a substrate (not shown) in several of the applications described above (e.g., head-of-wall applications, structural steel coating, and pipe and cable wraps).

In other embodiments (not shown in FIG. 4), the adhesive layer 25 may be adjacent to the second major surface 22b of the first layer 22 instead of or in addition to being adjacent to the polymeric film layer 27. In some embodiments, a release coating may be present on the second major surface 22b to promote release of the first layer 22 from the adhesive layer 25 when the article is wound in a roll. In some embodiments, the article 20 may be provided with a release liner (not shown) on the exposed surface of the adhesive layer 25. A release liner can be a paper liner or polymer film layer as described above in any of its embodiments with a release coating on at least one surface. Examples of suitable release coatings include silicone, fluorochemical, and carbamate coatings. In other embodiments (not shown in FIG. 4), the adhesive layer 25 may be directly adjacent to the first major surface 22a or second major surface 22b of the first layer 22, and the polymeric film layer 27 may be eliminated.

FIG. 5 illustrates an embodiment of the article 30 of the present disclosure. The article 30 includes a first layer 32 including a nonwoven web of blown microfibers and particles dispersed within the nonwoven web of blown microfibers. The article 30 also includes a foam layer 39. As described above, the first layer 32 may be directly formed on the foam layer 39. The first layer 32 may also be adhesively laminated to the foam layer 39 such that there is an adhesive layer (not shown) between the foam layer 39 and the first layer 32. In some embodiments, the first layer may be at least one of adhered, ultrasonically bonded, needle-tacked, or stitch bonded to the foam layer. The particles, blown microfibers, and foam layer can be any of those described above in any of their embodiments.

FIG. 6 illustrates an embodiment of the article 40 of the present disclosure. The article 40 includes a first layer 42 including a nonwoven web of blown microfibers and particles dispersed within the nonwoven web of blown microfibers. The article 40 also includes a sealant layer 43. The particles, blown microfibers, and sealant layer can be any of those described above in any of their embodiments. Sealant layers can be useful in any embodiments of the article in which a surface finish is desired. In the illustrated embodiment, the sealant layer 43 is adjacent to the first major surface 42a of the first layer 42. In other embodiments (not shown in FIG. 6), the sealant layer 43 may be adjacent to the second major surface 42b of the first layer 42 in addition to being adjacent to the first major surface 42a.

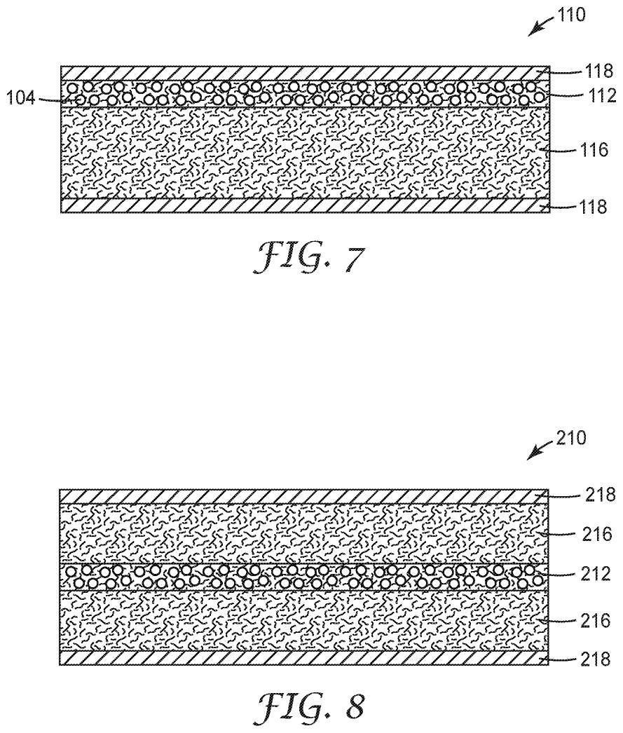

FIG. 7 illustrates an embodiment of the article 110 of the present disclosure. The article 110 includes a first layer 112 including a nonwoven web of blown microfibers and particles 104 dispersed within the nonwoven web of blown microfibers. The article 110 also includes a second layer 116 including inorganic fibers and an outer covering 118 of the article 110 at least partially encapsulating at least the first layer 112 and the second layer 116. When the outer covering 118 is said to at least partially encapsulate at least the first layer 112 and the second layer 116, it means that the first layer 112 and the second layer 116 are together at least partially encapsulated, not that the outer covering 118 encapsulates the first layer 112 and second layer 116 individually. In other words, the outer covering 118 does not have a portion between the first layer 112 and the second layer 116. The particles, blown microfibers, inorganic fibers, and outer covering can be any of those described above in any of their embodiments.

FIG. 8 illustrates another embodiment of the article of the present disclosure. The article 210 includes a first layer 212 including a nonwoven web of blown microfibers and particles dispersed within the nonwoven web of blown microfibers. The article 210 also includes second layers 216 including inorganic fibers. In the embodiment illustrated in FIG. 8, there are two of the second layers 216 with the first layer 212 between the two of the second layers 216. The second layers 216 may have the same thickness or different thicknesses. The outer covering 218 of the article 210 at least partially encapsulates at least the first layer 212 and the second layers 216. The particles, blown microfibers, inorganic fibers, and outer covering can be any of those described above in any of their embodiments.

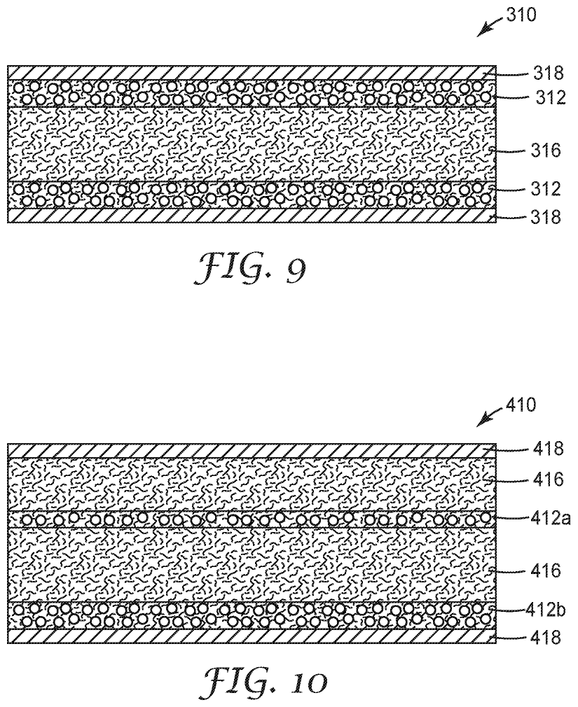

FIG. 9 illustrates another embodiment of the article of the present disclosure. The article 310 includes second layer 316 including inorganic fibers. The article 310 further includes first layers 312 including a nonwoven web of blown microfibers and particles dispersed within the nonwoven web of blown microfibers. In the embodiment illustrated in FIG. 9, there are two of the first layers 312 with the second layer 316 between the two of the first layers 312. The first layers 312 may have the same thickness or different thicknesses. Also, the first layers 312 may have the same particles or different particles. The outer covering 318 of the article 310 at least partially encapsulates at least the first layers 312 and the second layer 316. The particles, blown microfibers, inorganic fibers, and outer covering can be any of those described above in any of their embodiments.

FIG. 10 illustrates another embodiment of the article of the present disclosure. The article 410 includes first layers 412a and 412b including a nonwoven web of blown microfibers and particles dispersed within the nonwoven web of blown microfibers. The article 410 also includes second layers 416 including inorganic fibers. In the embodiment illustrated in FIG. 10, at least two of the first layers 412a, 412b alternate with at least two of the second layers 416. There may be additional alternating first layers 412a, 412b and second layers 416 although these are not shown in the embodiment illustrated in FIG. 10. The outer covering 418 of the article 410 at least partially encapsulates at least the first layers 412a, 412b and the second layers 416. As shown in FIG. 10, the first layers 412a, 412b may have different thicknesses, but they may also have the same thickness. Also, the first layers 412a, 412b may have the same particles or different particles. The second layers 416 may have the same thickness or different thicknesses. Although not shown, it is possible that each portion of outer covering 418 may be in contact with a second layer 416 or that each portion of outer covering 418 may be in contact with a first layer 412b. The particles, blown microfibers, inorganic fibers, and outer covering can be any of those described above in any of their embodiments.

In FIGS. 7 to 10, for example, a flame barrier paper can be located between the first layer and the second layer and/or between at least one of the first or second layer and the outer covering. A flame barrier paper can also be useful, in some embodiments, as the second layer comprising inorganic fibers.

In some embodiments of the article of the present disclosure and/or made or used in the processes of the present disclosure, including the embodiments illustrated in FIGS. 1 and 4 to 10, the article has a thickness of not more than 10 centimeters (cm), 9 cm, 8 cm, 7 cm, 6 cm, or 5 cm. In some embodiments, the article has a thickness in a range from 0.5 cm to 8 cm, from 1 cm to 8 cm, or from 2 cm to 7.5 cm.

The present disclosure provides a process for providing a fire barrier to a surface, the process comprising applying the article of the present disclosure and/or made according to the method of the present disclosure to the surface. Similarly, the present disclosure provides use of the article as a fire barrier. In some embodiments, the surface is a surface of a duct or pipe, and the process includes wrapping the article around a length of the duct or pipe, in some embodiments, in a single layer. In some embodiments, the duct is a grease duct.

A grease duct is a duct that is specifically designed to vent grease-laden vapors from commercial cooking equipment such as, stoves, pizza ovens, deep fryers, and woks to the outside of a building or mobile food preparation trailer. Grease ducts are regulated both in terms of their construction and maintenance, forming part of the building's passive fire protection system. Even the cleaning schedule is typically dictated by the fire code, and evidence of compliance must be kept on file by the owner. This is due, in part, to the fact that grease, during cooking, is heated to the point that it is carried up through the ducts as grease vapors. As the vapors travel through the ducts they are cooled, which causes the grease to precipitate and settle on the colder duct work. Typically, conventional grease ducts are made of carbon steel, fabricated, and welded into a rectangular shape or a circular shape.

Applying thermal and fire insulation fiber mats around grease ducts used in commercial kitchens prevents the spread of fire from the kitchen to other building compartments, thereby preventing catastrophic fire damage. Commercially available thermal insulation blankets are often thick and require the application of multiple layers of materials to achieve the required level of thermal insulation defined by the building code and fire protection guidelines. In general, commercial materials currently used and certified for grease duct applications use two layers of duct wrap. Applying two layers of duct wrap is not desirable for the installer for several reasons. First, there is generally minimal accessible space around grease ducts in building constructions, and applying two layers of duct wrap, which are generally each 1.5 to 2.0 inches (3.81 to 5 centimeters (cm)) thick, is often challenging. Second, applying two layers of duct wrap around the space-constrained ducts takes a longer time for the contractors, increasing labor costs. Third, each layer of duct wrap installation creates multiple joints where one piece of wrap meets the next. These joints require a particular installation procedure, which is quite time-consuming and labor-intensive.

Rolls of the article of the present disclosure can be supplied in pre-determined widths. Several segments of wrap may be required to wrap an entire length of duct or pipe. Aluminum foil tape, welded steel pins, and steel banding can be useful for securing the article around the duct using various techniques to ensure that no part of the duct is exposed. The articles 210, 310 illustrated in FIGS. 8 and 9 are essentially symmetrical. Accordingly, either face of the article 210, 310 may be applied to the surface of the duct or pipe or other substrate (not shown) without changing the construction of the wrapped article. The articles 110, 410 illustrated in FIGS. 7 and 10 are not symmetrical. In some embodiments, the article may be applied so that a first layer 112, 412b is in closer proximity to the outer surface of the duct, pipe, or other substrate. In some embodiments, the article may be applied so that a second layer 116, 416 is in closer proximity to the outer surface of the duct, pipe, or other substrate.

Examples of the article of the present disclosure are advantageously fire resistant. Examples 7 to 9, for example, passed UL 94, Tests for Flammability of Plastic Materials for Parts in Devices and Appliances with a rating of VO. In some embodiments, advantageously, the article meets the acceptance criteria of ASTM E2336. One acceptance criterion for ASTM E2336 is that when the minimum average temperature inside the grease duct is 2000° F. (1093° C.), no unexposed surface thermocouple used in the Internal Fire Test evaluation measures more than 325° F. (181° C.) above its initial temperature. As shown in a comparison of Examples 15 to 21 to Illustrative Example 1, the cold face of the article of the present disclosure can remain below a temperature 400° F. (204° C.), which is room temperature (75° F.) plus 325° F. (163° C.), for a time as long or longer (in some embodiments, 30% to 85% longer) than two layers of Duct Wrap obtained under the trade designation “3M FIRE BARRIER DUCT WRAP 615+”, from 3M Company, when the hot face is exposed to 2000° F. (1093° C.). This performance is achieved even though Examples 15 to 21 are 17% to 44% thinner than the two layers of the Duct Wrap.

### Some Embodiments of the Disclosure

In a first embodiment, the present disclosure provides an article comprising a first layer comprising a nonwoven web of blown microfibers and particles dispersed within the nonwoven web of blown microfibers, wherein the particles comprise at least one of endothermic particles or intumescent particles, wherein the particles are present in an amount of at least 80 weight percent, based on a total weight of the first layer, and wherein the at least one of endothermic particles or intumescent particles make up at least half of the total weight of the particles.

In a second embodiment, the present disclosure provides the article of the first embodiment, wherein the blown microfibers comprise at least one of a polyolefin, a polyester, a polyamide, a polyurethane, polylactic acid, polyphenylene sulfide, polysulfone, liquid crystalline polymer, polyethylene-co-vinylacetate, polyacrylonitrile, or a cyclic polyolefin. In a third embodiment, the present disclosure provides the article of the first or second embodiment, wherein the blown microfibers comprise at least one of polyethylene terephthalate, polybutylene terephthalate, polyethylene, polypropylene, or polybutene. In a fourth embodiment, the present disclosure provides the article of any one of the first to third embodiments, wherein the blown microfibers comprise polypropylene. In a fifth embodiment, the present disclosure provides the article of any one of the first to fourth embodiments, wherein the particles are present in an amount of at least 82.5 wt. %, at least 85 wt. %, at least 87.5 wt. %, at least 90 wt. %, at least 92.5 wt. %, or at least 95 wt. %, based on the total weight of the first layer. In a sixth embodiment, the present disclosure provides the article of any one of the first to fifth embodiments, wherein the organic polymer fibers and the particles make up at least 80, 85, 90, 95, 96, 97, or 98 percent of the total weight of the first layer.

In a seventh embodiment, the present disclosure provides the article of any one of the first to sixth embodiments, wherein the endothermic particles are present in an amount of at least 40 wt. %, at least 50 wt. %, at least 60 wt. %, at least 70 wt. %, at least 80 wt. %, at least 82.5 wt. %, at least 85 wt. %, at least 87.5 wt. %, at least 90 wt. %, at least 92.5 wt. %, or at least 95 wt. %, based on the total weight of the first layer. In an eighth embodiment, the present disclosure provides the article of any one of the first to seventh embodiments, wherein the intumescent particles are present in an amount of at least 40 wt. %, at least 50 wt. %, at least 60 wt. %, at least 70 wt. %, at least 80 wt. %, at least 82.5 wt. %, at least 85 wt. %, at least 87.5 wt. %, at least 90 wt. %, at least 92.5 wt. %, or at least 95 wt. %, based on the total weight of the first layer. In a ninth embodiment, the present disclosure provides the article of any one of the first to eighth embodiments, wherein the particles comprise at least one of aluminum hydroxide, magnesium hydroxide, intumescent graphite, unexpanded vermiculite, or an intumescent silicate. In a tenth embodiment, the present disclosure provides the article of any one of the first to ninth embodiments, wherein the particles comprise at least one of aluminum hydroxide, intumescent graphite, or an intumescent silicate. In an eleventh embodiment, the present disclosure provides the article of any one of the first to sixth or eighth to tenth embodiments, wherein the intumescent particles comprise and/or wherein the intumescent silicate is a mixture of alkali metal silicate, represented by the formula M₂O:xSiO₂, wherein M is the alkali metal; at least one oxy boron compound selected from the group consisting of boric acid and borate salts of Group I and II elements; and water; wherein x ranges from about 1.5 to about 4, a molar ratio of boron to M is between about 0.2 and about 0.9, and the water makes up about 5 to 15 weight percent of the mixture.

In a twelfth embodiment, the present disclosure provides the article of any one of the first to eleventh embodiments, wherein the particles further comprise flame retardant particles comprising at least one of a phosphorous-containing compound, a boron-containing compound, or a nitrogen-containing polymer. In a thirteenth embodiment, the present disclosure provides the article of any one of the first to twelfth embodiments, wherein the particles further comprise staple fibers. In a fourteenth embodiment, the present disclosure provides the article of the thirteenth embodiment, wherein the staple fibers comprise at least one of inorganic fibers, polyphenylene sulfide fibers, and oxidized polyacrylonitrile fibers. In a fifteenth embodiment, the present disclosure provides the article of any one of the first to fourteenth embodiments, wherein the particles further comprise inorganic filler. In a sixteenth embodiment, the present disclosure provides the article of any one of the first to fifteenth embodiments, wherein the particles further comprise char-forming organic particles.

In a seventeenth embodiment, the present disclosure provides the article of any one of the first to sixteenth embodiments, further comprising at least one of an adhesive layer, a polymeric film layer, a foam layer, a sealant layer, a second layer comprising inorganic fibers, a flame barrier paper layer, or an outer covering comprising a metal at least partially encapsulating at least the first layer. In an eighteenth embodiment, the present disclosure provides the article of any one of the first to seventeenth embodiments, wherein the article has a thickness of not more than 10, 9, 8, 7, 6, or 5 centimeters.

In a nineteenth embodiment, the present disclosure provides the article of any one of the first to eighteenth embodiments, further comprising a second layer adjacent the first layer, wherein the second layer comprises inorganic fibers, and an outer covering at least partially encapsulating at least the first layer and the second layer. In a twentieth embodiment, the present disclosure provides the article of the seventeenth or nineteenth embodiment, wherein the inorganic fibers comprise ceramic fibers. In a twenty-first embodiment, the present disclosure provides the article of the nineteenth or twentieth embodiment, wherein the outer covering comprises a metal. In a twenty-second embodiment, the present disclosure provides the article of any one of the nineteenth to twenty-first embodiments, wherein the outer covering is at least one of a scrim-reinforced metal foil or a fiberglass reinforced metalized polymer foil. In a twenty-third embodiment, the present disclosure provides the article of any one of the nineteenth to twenty-second embodiments comprising two of the first layers with the second layer between the two of the first layers, two of the second layers with the first layer between the two of the second layers, or at least two of the first layers alternating with at least two of the second layers. In a twenty-fourth embodiment, the present disclosure provides the process of making the article of any one of nineteenth to twenty-third embodiments, the process comprising positioning the first layer next to the second layer and wrapping the outer covering at least partially around the first layer and the second layer. In a twenty-fifth embodiment, the present disclosure provides the process of the twenty-fourth embodiment, further comprising at least one of adhering, ultrasonic bonding, or stitch bonding the first layer to the second layer. In a twenty-sixth embodiment, the present disclosure provides the process of the twenty-fourth or twenty-fifth embodiment, wherein positioning the first layer next to the second layer comprises positioning the second layer between two of the first layers, positioning the first layer between two of the second layers, or positioning at least two of the first layers to alternate with at least two of the second layers.

In a twenty-seventh embodiment, the present disclosure provides a process for making the article of any one of the first to eighteenth embodiments, the process comprising forming the blown microfibers, delivering the particles to the blown microfibers, and collecting the blown microfibers and the particles to form the nonwoven web with the particles dispersed within the nonwoven web. In a twenty-eighth embodiment, the present disclosure provides the process of the twenty-seventh embodiment, wherein forming the blown microfibers and delivering the particles to the blown microfibers are carried out simultaneously.

In a twenty-ninth embodiment, the present disclosure provides a process for providing a fire barrier to a surface, the process comprising applying the article of any one of the first to twenty-third embodiments to the surface. In a thirtieth embodiment, the present disclosure provides the process of the twenty-ninth embodiment, wherein the surface is a surface of a duct or pipe, and wherein applying the article comprises wrapping the article around a length of the duct. In a thirty-first embodiment, the present disclosure provides the process of the thirtieth embodiment, wherein wrapping the article around the length of the duct or pipe comprises wrapping a single layer of the article around the length of the duct or pipe. In a thirty-second embodiment, the present disclosure provides the process of the thirtieth or thirty-first embodiment, wherein the article meets the acceptance criteria of ASTM E2336. In a thirty-third embodiment, the present disclosure an article wrapped with a single layer of the article of any one of the nineteenth to twenty-third embodiments. In a thirty-third embodiment, the present disclosure provides the process or article of any one of the twenty-ninth to thirty-second embodiments, wherein the duct is a grease duct.

In a thirty-fourth embodiment, the present disclosure provides use of the article of any one of the first to twenty-third embodiments as a fire barrier. In a thirty-fifth embodiment, the present disclosure provides the use of the thirty-fourth embodiment, wherein the fire barrier is a duct wrap, a pipe wrap, a blanket, or a tape. In a thirty-sixth embodiment, the present disclosure provides the process of the thirty-fourth or thirty-fifth embodiment, wherein the fire barrier is a duct wrap applied in a single layer.

### Examples

Various embodiments of the present disclosure can be better understood by reference to the following Examples which are offered by way of illustration. The present disclosure is not limited to the Examples given herein.

The following abbreviations are used in this section: in =inch, cm=centimeter, m=meter, gsm=gram per square meter, min=minute, mm=millimeter, lb=pound, kg=kilogram, hr=hour, rpm=revolutions per minute, ° C.=degrees Celsius, Pa=Pascal, cc=cubic centimeter, 1=liter, lpm=liter per minute, SCFM=standard cubic feet per minute, fpm=feet per minute, wt. %=weight percent, and %/w=percent by weight.

TABLE 1
Materials List

| Abbreviation | Description |
|---|---|
| PP | Polypropylene, obtained under the trade designation “MF650Y”, from |
| | Lyondellbasell, Houston, TX |
| ATH | Aluminum Trihydrate, obtained under the trade designation “SB-30 ATH”, from |
| | J.M. Huber Co, Commerce, GA |
| Graphite | Intumescent Graphite, obtained under the trade designation “ASBURY 3772”, |
| | from Asbury Carbons, Asbury, NJ |
| Silicate | Intumescent Sodium Silicate, obtained under the trade designation “3M |
| | EXPANTROL 4BW” from 3M Company, St Paul, MN |
| Red Dye | Techmer PPM412895 is a polymer modifier red colorant, TechmerPM |
| | Polymer Modifers, Clinton, TN |
| VA | Vinnapas B17 is a food grade vinyl acetate homopolymer in solid form, |
| | Wacker, Munchen, Germany |
| PW | Plenum Wrap, obtained under the trade designation “3M FIRE BARRIER |
| | PLENUM WRAP 5A+”, from 3M Company |
| Duct Wrap | Duct Wrap, obtained under the trade designation “3M FIRE BARRIER DUCT |
| | WRAP 615+”, from 3M Company |
| MW | Mineral wool, 6 pcf, Roxul Inc., Denmark |
| Facing | Scrim-Reinforced Foil (commonly known as facing) removed from the product |
| | sold under the trade designation “3M FIRE BARRIER PLENUM WRAP 5A+”, |
| | 3M Company |

### Test Methods

### Base Web Basis Weight and Total Web Basis Weight Measurements (Gsm)

The basis weight of blown microfiber webs without particles were determined by weighing 5.25 in (13.34 cm) diameter die-cut circular discs on a scale (Model Number MS403TS/00, available from Mettler Toledo, LLC, Columbus, Ohio), leveled, calibrated, tared, and set to readout to 0.001 grams. The weight in grams per circle was then converted to grams per square meter, or gsm, using the equations below:
C1=weight, in grams, of a circle cut from the nonwoven layer having a diameter of 5.25 in (13.34 cm)
Basis Weight, gsm=(C1/(Area of a 13.34 cm Circle, in meters squared)
Basis Weight, gsm=C1/(0.013966 in²) These results are presented as “Base Web Basis Weight (gsm)” in Table 2.

Basis weight of webs with particles were determined by weighing 5.25 in (13.34 cm) diameter die-cut circular discs using the same method. These results are presented as “Total Web Basis Weight (gsm)” in Tables 2 and 3.

### Nonwoven Thickness Measurement (mm)

The sample thickness of a 5.25 in (13.34 cm) diameter die-cut disc was measured using a thickness testing gauge having a tester foot with dimensions of 5 cm×12.5 cm at an applied pressure of 150 Pa. The measurements are presented in Tables 2 and 3.

### Effective Fiber Diameter (EFD) Measurement (Micron)

The effective fiber diameter was determined by first determining the following:
C1=weight, in grams, of a circle cut from the nonwoven layer having a diameter of 5.25 in (13.34 cm)
rho=density of the polymer of the fibers (g/cc)
T=thickness of nonwoven layer in mils (e.g., 1 mil=0.001 in)
ΔP=pressure drop in mm H₂O measured at a flow rate of 85 l/min. The pressure drop was measured as described below.

The effective fiber diameter (EFD) was then calculated from the following equations:

$$V = C 1 / rho / T$$

$$W = {V}^{1.5}$$

$$X = 1254.37 ⋆ {V}^{4.5}$$

$$Y = T / Δ P$$

$$Z = ( W + X ) ⋆ Y$$

$$EFD ( microns ) = 44.85 ⋆ {Z}^{0.5}$$

The measurements are presented in Tables 2 and 3.

### Pressure Drop Test (Mm H₂O at 85 Lpm)

A high-speed automated filter tester built to be similar to Model 8130, available from TSI Inc., Shoreview, MN, was operated with particle generation and measurement turned off. The flow rate was adjusted to 85 lpm, and a 5.25 in (13.34 cm) diameter die-cut sample was used. The sample was placed onto the lower circular plenum opening, and the tester was engaged. A pressure transducer (available from MKS Instruments, Inc., Andover, MA) within the device measured the pressure drop (mm H₂O). The measurements are presented in Tables 2 and 3.

### Solidity Measurement (%)

Fiber solidity was calculated based on the below equation. Polymer density for polypropylene is 0.91 g/cc.
C1=weight, in grams, of a circle cut from the nonwoven layer having a diameter of 5.25 in
rho=density of the polymer of the fibers in g/cc.
T=thickness of nonwoven layer in mils (e.g. 1 mil=0.001 in)

The % Solidity was then calculated from the following equations:

$$A = 100 ⋆ 0.0028189 ⋆ C 1$$

$$B = 0.001 ⋆ T ⋆ rho$$

$$\% Solidity = A / B$$

The measurements are presented in Tables 2 and 3.

### Particle Loading Measurement (Wt. %)

For articles comprising one base nonwoven web, particle-loading (wt. %) was calculated as the ratio of the difference between the Total Web Basis Weight and the Base Web Basis Weight to the Total Web Basis Weight, multiplied by 100%. For example, in Example BMF1, the Base Web Basis Weight was 505 gsm and the Total Web Basis Weight was 4692 gsm. The particle-loading (wt. %) would be calculated as:

(4692 gsm−505 gsm)/4692 gsm×100=89%. The results are presented in Tables 2 and 3.

Particle Measurement (%/w)

Particles were added as either a single component or two component mixture and listed in Table 2 as Particle 1 and Particle 2. The %/w was the percent by weight of each Particle utilized in the Particle-Loaded BMF Sample Preparation. For example, in Example BMF4, Particle 1 was ATH; Particle 2 was Graphite. Prior to loading the hopper of the Particle Loader, a 10 lb (4.55 kg) batch of particles was blended in a steel bucket at a 90:10 ratio. The calculations for the amounts of particles were as follows:

### Particle 1: ATH, 90° o/w

$$Amount of ATH = 90 \% ⋆ 10 lb ( 4.55 kg ) = 9. lb ( 4.08 kg )$$

### Particle 2: Graphite, 10%/w

$$Amount of Graphite = 10 \% ⋆ 10 lb = 1. lb ( 0.455 kg )$$

Hence, 9.0 lb (4.08 kg) of ATH and 1.0 lb (0.455 kg) of Graphite were placed in a steel bucket, dry blended with a spatula, and poured into the hopper of the Particle Loader. Measurements are presented in Tables 2 and 3.

### Fire Test-1

Sample duct constructions were tested according to ASTM 814-13a (2017) “Standard Test Method for Fire Tests of Penetration Firestop Systems” except that the temperature profile followed ASTM E2336-20, Standard Test Methods for Fire Resistive Grease Duct Enclosure Systems, internal fire test (section 13.4) requirements.

A 16 gauge 4 in×4 in (1.2 m×1.2 m) steel plate was placed on the furnace as a representative of the duct. Two layers of Duct Wrap were placed on the steel plate. Four 200 mm×200 mm openings were cut into the two layers of Duct Wrap (centered on the plate as a 2×2 grid with all openings 100 mm from each other). Samples (200 mm×200 mm), wrapped in Facing, were placed into the previously described openings. Thermocouples were placed on the center of the top surface of each sample to monitor temperatures. The hot face was considered where the sample was in contact with the steel plate and the cold side was the outer surface that was in contact with the thermocouple.

In the Fire Test, the samples were exposed to a temperature of 500° F. (260° C.) for 4 hours. Then, the furnace temperature was increased to 2000° F. (1093° C.) and held for a minimum of 30 min or until samples reached 400° F. (204° C.).

The T-rating was the time to reach a temperature of 400° F. (204° C.) on the cold side of the construction. This is based upon ASTM E2336, individual maximum thermocouple temperature, of room temp (75° F.) plus 325° F. (163° C.). The results are presented with Illustrative Examples A to C and Examples 15 to 21 below.

### Fire Test-2

UL 94, Tests for Flammability of Plastic Materials for Parts in Devices and Appliances was conducted as described. As stated in the standard, a 5 inch by 0.5 inch (12.7 cm×1.27 cm) sample was exposed to the flame in the vertical orientation.

### BMF Sample Preparation and Particle-Loaded BMF Example Preparation (EX1 to EX14)

PP was extruded through a 22 mm conical counter rotating twin-screw extruder (Model Mark II Conical Twin Screw Extruder [CTSE Counter Rotating], C.W. Brabender Instruments, Inc., South Hackensack, NJ) using an extrusion rate of 10 lb/hr (4.54 kg/hr) and a barrel temperature profile of 210° C., 230° C., and 250° C. with the melt pump, purge block, neck tube, and die zones all set to 250° C. A screw speed of 147 rpm was used. The thermoplastic polymer streams were extruded through a die containing closely arranged orifices which were then subjected to a high velocity stream of heated air set to a temperature of 245° C. and approximately 93 SCFM at the die exit (these processing conditions such as barrel temperature, air temperature, or air pressure can fluctuate by a range of approximately +5%). The polymer streams exiting the orifices of the die were attenuated by convergent streams of hot air at high velocities to form fine fibers, which were then collected on a surface to provide a melt-blown non-woven fibrous layer, or mat. This method of polypropylene blown microfibers was similar to U.S. Pat. No. 3,971,373 (Braun). The fibrous layer consisting of only BMF fibers was tested using the Basis Weight Measurement, Nonwoven Thickness Measurement, and Pressure Drop Test, as described in the Test Methods, to determine the properties of the base BMF media that include the calculations for Effective Fiber Diameter (EFD) Measurement and % Solidity Measurement prior to the addition of particles.

Next, particles were incorporated into the constituent fibers during the direct formation of the fibers in order to produce the final, particle-loaded media of interest. The particles were conveyed and co-mingled with the streams of molten polymer as they were blown onto a rotating collector drum. Depending on the total Basis Weight desired, the Particle Loader was set at 293-944 rpm to produce the desired Example. The particles were entrained within a flow of heated air that converges with the hot air used to attenuate the melt blown fibers. The polypropylene blown microfibers and particles were collected in a random fashion on a collection drum with a perforated surface to allow vacuum suction through the blown microfiber mat, further enhancing the material properties of the resulting media. In these examples, the Collection Drum was set at a distance of 14 inches from the Die Face. The Collector Speed was 1.8-9.3 fpm, depending on which Example was produced, and the Collector Exhaust Flow was 1850-2175 SCFM, equaling 13.25-13.7 inches of water differential pressure (or vacuum). The nonwoven mat was then removed from the collection drum and formed into a roll via surface winding equipment. A second set of samples were then tested for Basis Weight Measurement, Nonwoven Thickness Measurement, and Pressure Drop, as described in the Test Methods, to determine the properties of the total, or final particle-loaded media properties that also included calculations for Effective Fiber Diameter (EFD) Measurements and % Solidity Measurements. In order to expedite the calculations, the density of the polymer was used in these measurements and calculations rather than use additional equations that would include the density of the particles since the relative weight of non-particle-loaded media versus particle-loaded media was more important than the actual, calculated bulk density of the fibrous media with particles.

All Particle-Loaded BMF Examples (EX1 to EX14) were made via Particle-Loaded BMF Example preparation described above, utilizing particles as named below. BMF Basis Weight, Thickness, Effective Particle Diameter (EFD), Pressure Prop, % Solidity, Particle Loading, and Particle Measurement were measured according to the Test Methods provided. The results are reported in Tables 2 and 3.

For Examples EX12 to EX14, a combination of PP and Red Dye was used to make the blown microfibers instead of PP alone as shown in Table 3, below.

TABLE 2
BMF Samples and Particle-Loaded BMF Samples (EX1 to EX9)

| | EX1 | EX2 | EX3 | EX4 | EX5 | EX6 | EX7^{c} | EX8^{c} | EX9^{c} |
|---|---|---|---|---|---|---|---|---|---|
| Base Web | 505 | 142 | 200 | 102 | 102 | 98 | 496 | 102 | 306 |
| Basis | | | | | | | | | |
| Weight | | | | | | | | | |
| (gsm) | | | | | | | | | |
| Base Web | 9.7 | 2.8 | 3.6 | 2.2 | 2.2 | 1.6 | nm^{b} | nm | nm |
| Thickness | | | | | | | | | |
| (mm) | | | | | | | | | |
| Base Web | 5.7 | 6 | 5.4 | 6.4 | 6.4 | 6 | 5.8 | 6.1 | 6 |
| EFD | | | | | | | | | |
| (micron) | | | | | | | | | |
| Base Web | 69 | 30 | 32 | 11 | 11 | 13 | 69 | 14 | 35 |
| Pressure | | | | | | | | | |
| Drop | | | | | | | | | |
| Base Web | 5.7 | 5 | 6 | 5.2 | 5.2 | 6.8 | 6.2 | 7 | 4.9 |
| Solidity (%) | | | | | | | | | |
| Particle 1 | ATH | graphite | ATH | ATH | ATH | ATH | silicate | ATH | ATH |
| Particle 1 | 100 | 100 | 100 | 90 | 75 | 50 | 100 | 100 | 30 |
| (%/w) | | | | | | | | | |
| Particle 2 | NA^{a} | NA | NA | graphite | graphite | silicate | NA | NA | graphite |
| Particle 2 | NA | NA | NA | 10 | 25 | 50 | NA | NA | 70 |
| (%/w) | | | | | | | | | |
| Total Web | 4692 | 2789 | 4354 | 2007 | 1946 | 2752 | 4451 | 2214 | 2855 |
| Basis | | | | | | | | | |
| Weight | | | | | | | | | |
| (gsm) | | | | | | | | | |
| Particle | 89 | 95 | 95 | 95 | 95 | 96 | 89 | 95 | 89 |
| Loading | | | | | | | | | |
| (wt. %) | | | | | | | | | |
| Total Web | 16 | 10 | 9 | 5 | 7 | 7 | 15 | 5 | 13 |
| Thickness | | | | | | | | | |
| (mm) | | | | | | | | | |
| Total Web | 47 | 120 | 126 | 90 | 54 | 123 | nm | nm | nm |
| EFD | | | | | | | | | |
| (micron) | | | | | | | | | |
| Total Web | 59 | 28 | 33 | 18 | 16 | 14 | nm | nm | nm |
| Pressure | | | | | | | | | |
| Drop | | | | | | | | | |
| Total Web | 31 | 48 | 53 | 44 | 29 | 45 | nm | nm | nm |
| Solidity (%) | | | | | | | | | |

^{a}NA = not applicable.
^{b}nm = not measured.
^{c}Examples 7 to 9 were subjected to Fire Test-2, and each had a rating of V0.

TABLE 3
BMF Samples and Particle-Loaded BMF Examples (EX10 to EX14)

| | EX10 | EX11 | EX12 | EX13 | EX14 |
|---|---|---|---|---|---|
| PP (wt. % of Base Web) | 100 | 100 | 95 | 95 | 95 |
| Red Dye (wt. %) | 0 | 0 | 5 | 5 | 5 |
| Base Web Basis Weight | 513 | 513 | 102 | 75 | 50 |
| (gsm) | | | | | |
| Base Web EFD (micron) | 6 | 6 | 7.5 | nm | nm |
| Base Web Pressure Drop | 63 | 63 | 7.3 | nm | nm |
| Base Web Solidity (%) | 5.6 | 5.6 | 4.7 | nm | nm |
| Particle 1 | ATH | ATH | ATH | ATH | ATH |
| Particle 1 (%/w) | 40 | 40 | 100 | 50 | 50 |
| Particle 2 | graphite | graphite | NA | silicate | graphite |
| Particle 2 (%/w) | 40 | 20 | NA | 50 | 50 |
| Particle 3 | VA | VA | NA | NA | NA |
| Particle 3 (%/w) | 20 | 40 | NA | NA | NA |
| Total Web Basis Weight | 3361 | 3310 | 1963 | 1162 | 584 |
| (gsm) | | | | | |
| Particle Loading (wt. %) | 85 | 95 | 95 | 94 | 91 |
| Total Web Thickness (mm) | 17 | 15 | 5 | 3 | 2.4 |

### Multilayer Examples 15 to 21 and Illustrative Examples A to C

All samples were cut to 200 mm×200 mm (length by width) and the finished stacked samples were wrapped in Facing, prior to placing into position for testing according to Fire Test-1.

Illustrative Example A was prepared by stacking a layer of Duct Wrap (44 mm thick) on the hot face, followed by a layer of Duct Wrap (44 mm thick). During Fire Test-1, the T-Rating was 30 minutes.

Illustrative Example B was prepared by stacking a layer of Duct Wrap (44 mm thick) on the hot face, followed by a layer of PW (13 mm thick). During Fire Test-1, the T-Rating was 18 minutes.

Illustrative Example C was prepared for testing by stacking a layer of Duct Wrap (44 mm thick) on the hot face, followed by a layer of MW (40 mm thick). During Fire Test-1, the T-Rating was 21 minutes.

Example 15 was prepared by stacking a layer of PW (13 mm thick) on the hot face, followed by a layer of EX1 (16 mm thick), and a layer of Duct Wrap (44 mm thick). During Fire Test-1, the T-Rating was 31 minutes.

Example 16 was prepared for testing by stacking a layer of PW (13 mm thick) on the hot face, followed by a layer of EX2 (10 mm thick), a layer of PW (13 mm thick), and a layer of PW (13 mm thick). During Fire Test-1, the T-Rating was 55 minutes.

Example 17 was prepared by stacking a layer of Duct Wrap (44 mm thick) on the hot face, followed by a layer of EX3 (9 mm thick), and a layer of PW (13 mm thick). During Fire Test-1, the T-Rating was 40 minutes.

Example 18 was prepared by stacking a layer of Duct Wrap (44 mm thick) on the hot face, followed by a layer of EX4 (5 mm thick), and a layer of PW (13 mm thick). During Fire Test-1, the T-Rating was 33 minutes.

Example 19 was prepared by stacking a layer of Duct Wrap (44 mm thick) on the hot face, followed by a layer of EX5 (7 mm thick), and a layer of PW (13 mm thick). During Fire Test-1, the T-Rating was 30 minutes.

Example 20 was prepared by stacking a layer of Duct Wrap (44 mm thick) on the hot face, followed by a layer of EX6 (7 mm thick), and a layer of PW (13 mm thick). During Fire Test-1, the T-Rating was 39 minutes.

Example 21 was prepared by stacking a layer of PW (13 mm thick) on the hot face, followed by a layer of EX2 (10 mm thick), a layer of PW (13 mm thick), a layer of EX3 (9 mm thick), and a layer of PW (13 mm thick). During Fire Test-1, the T-Rating was 50 minutes.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

1. An article comprising:
a first layer comprising a nonwoven web of blown microfibers and particles comprising at least one of endothermic particles or intumescent particles dispersed within the nonwoven web of melt blown fibers, wherein the particles are present in an amount of at least 80 weight percent, based on a total weight of the first layer, and wherein the at least one of endothermic particles or intumescent particles make up at least half of the total weight of the particles.

2. The article of claim 1, wherein the blown microfibers comprise at least one of a polyolefin, a polyester, a polyamide, a polyurethane, polylactic acid, polyphenylene sulfide, polysulfone, liquid crystalline polymer, polyethylene-co-vinylacetate, polyacrylonitrile, or a cyclic polyolefin.

3. The article of claim 1, wherein the blown microfibers and the particles make up at least 98 percent of the total weight of the first layer.

4. The article of claim 1, wherein the at least one of endothermic particles or intumescent particles comprise at least one of aluminum hydroxide, magnesium hydroxide, intumescent graphite, unexpanded vermiculite, or an intumescent silicate.

5. The article of claim 1, wherein the particles further comprise fire retardant particles comprising at least one of a phosphorous-containing compound, a boron-containing compound, or a nitrogen-containing polymer.

6. The article of claim 1, wherein the particles further comprise staple fibers.

7. The article of claim 6, wherein the staple fibers comprise at least one of inorganic fibers, polyphenylene sulfide fibers, and oxidized polyacrylonitrile fibers.

8. The article of claim 1, wherein the particles further comprise inorganic filler.

9. The article of claim 1, wherein the particles further comprise char-forming organic particles.

10. The article of claim 1, further comprising at least one of an adhesive layer, a polymeric film layer, a foam layer, a sealant layer, a second layer comprising inorganic fibers, a flame barrier paper layer, or an outer covering comprising a metal at least partially encapsulating at least the first layer.

11. The article of claim 1, further comprising:
a second layer adjacent the first layer, wherein the second layer comprises inorganic fibers; and
an outer covering comprising a metal at least partially encapsulating at least the first layer and the second layer.

12. A process for making the fire barrier article of claim 1, the process comprising:
forming the blown microfibers;
delivering the particles to the blown microfibers; and
collecting the blown microfibers and the particles to form the nonwoven web with the particles dispersed within the nonwoven web.

13. The process of claim 12, wherein forming the blown microfibers and delivering the particles to the blown microfibers are carried out simultaneously.

14. A process for providing a fire barrier to a surface, the process comprising:
applying the article of claim 1 to the surface.

15. The article of claim 1, wherein the article is a fire barrier, and wherein the fire barrier is a duct wrap, a pipe wrap, a blanket, or a tape.

16. The article of claim 11, wherein the inorganic fibers comprise ceramic fibers.

17. The article of claim 1, wherein the blown microfibers comprise polypropylene.

18. The article of claim 1, wherein the endothermic particles are present in an amount of at least 40 weight percent, based on the total weight of the first layer.

19. The article of claim 1, wherein the intumescent particles are present in an amount of at least 40 weight percent, based on the total weight of the first layer.

20. The article of claim 1, wherein the article has a thickness of not more than 10 centimeters.
